(19) United States
(12) Patent Application Publication
(10) Pub. No.: US 2006/0095299 A1
(43) Pub. Date: May 4, 2006

(54) Monitoring adherence to evidence-based medicine guidelines

(76) Inventor: William J. Hilliard, San Francisco, CA (US)

Correspondence Address: IRELL & MANELLA LLP, 1800 AVENUE OF THE STARS, SUITE 900, LOS ANGELES, CA, 90067, US

(21) Appl. No.: 11/265,989

(22) Filed: Nov. 2, 2005

Related U.S. Application Data
(60) Provisional application No. 60/624,342, filed on Nov. 2, 2004.

(51) Int. Cl. G06Q 10/00; H04M 3/51

(52) U.S. Cl. 705/2; 705/11

(57) ABSTRACT

A medical rating system may include a set of rules of good medical practice, a rating agency providing a rating and a rating indicator based in part on the physician's adherence to rules of good medical practice.

### RELATED APPLICATIONS

This application claims the priority of U.S. Provisional Application Ser. No. 60/624,342 filed Nov. 2, 2004.

### BACKGROUND OF THE INVENTION

1. Field of the Invention

The present invention is related to techniques for monitoring and using physician's adherence to evidence-based medicine guidelines, particularly generally approved care guidelines.

2. Description of the Prior Art

It is generally accepted that access to good medical care is one of the most critical items facing American society. Even when access is available, studies show that Americans don't always receive generally accepted medical treatment plans from their doctors. The doctor's failure to follow generally accepted medical treatment plans has been variously ascribed to inadequate physician training or due to misaligned incentives in our American 3rd-party payer medical insurance reimbursement system. It has been said that our American medical insurance system, together with current practices in medical malpractice litigation, may incentivize doctors to over-perform high cost procedures, for example, to reduce their exposure to litigation.

The medical establishment in our country has developed what are called “best practice” guidelines for treatment of many illnesses. Adherence to these guidelines is known in the industry as “evidence-based medicine.” More than 100 evidence-based guidelines have been developed by medical schools, specialty medical groups, government agencies and health-care companies, ranging from how to treat common ailments such as asthma and hypertension, to how to perform surgeries and tackle serious diseases like cancer.

According to a Rand Corporation survey, patients get the recommended care only about half of the time, with consequences that are avoidable. For example, the survey results indicate that only 64.7% of hypertension patents, 63.9% of congestive heart failure patents, 53.9% of colorectal cancer patents, 53.5% of asthma patents, 45.4% of diabetes patents, 30.9% of pneumonia patients and 22.8% of hip fracture patients received the recommended care for their diseases or condition.

According to the Rand Corporation survey, 64.7% of patients with hypertension received indicated care, resulting in 68,000 avoidable deaths. 39-55% of heart attack victims didn't receive needed medications, resulting in 37,000 avoidable deaths. And 36% of elderly patients didn't receive vaccine for pneumonia, resulting in 10,000 avoidable deaths. In total, up to 98,000 Americans die each year from preventable medical mistakes they experience during hospitalizations, according to the Institute of Medicine (IOM, 1999), a congressionally chartered, independent organization that provides objective, timely, authoritative information to improve human health. And this does not include harm from mistakes made in the outpatient setting.

Part of the problem in providing recommended care for patients results from our fragmented health-care system. In addition, TV and magazine advertising creates demand from patients for certain treatments that may not be the best for the specific patent's condition. Moreover, many doctors don't use recommended care paths because they are just not aware of them. According to the Institute of Medicine, the lag between the discovery of effective treatments and their incorporation into routine care is 17 years.

In addition to deaths from incorrect treatment, our current medical system is burdened with extra expense. Doctors who fail to follow recommended treatment plans bill insurance companies and Medicare for unneeded treatments that are not clinically indicated by best practices guidelines. This additional billing contributes to costs spiraling out of control.

What are needed are improvements in aspects of our medical health access, delivery and reimbursement systems.

### BRIEF DESCRIPTION OF THE DRAWINGS

FIG. 1 is a diagram of the relationship between the patient, physician and health care system.

FIG. 2 is an example of a type of placard rating system.

FIG. 3 is a flow chart of an audit.

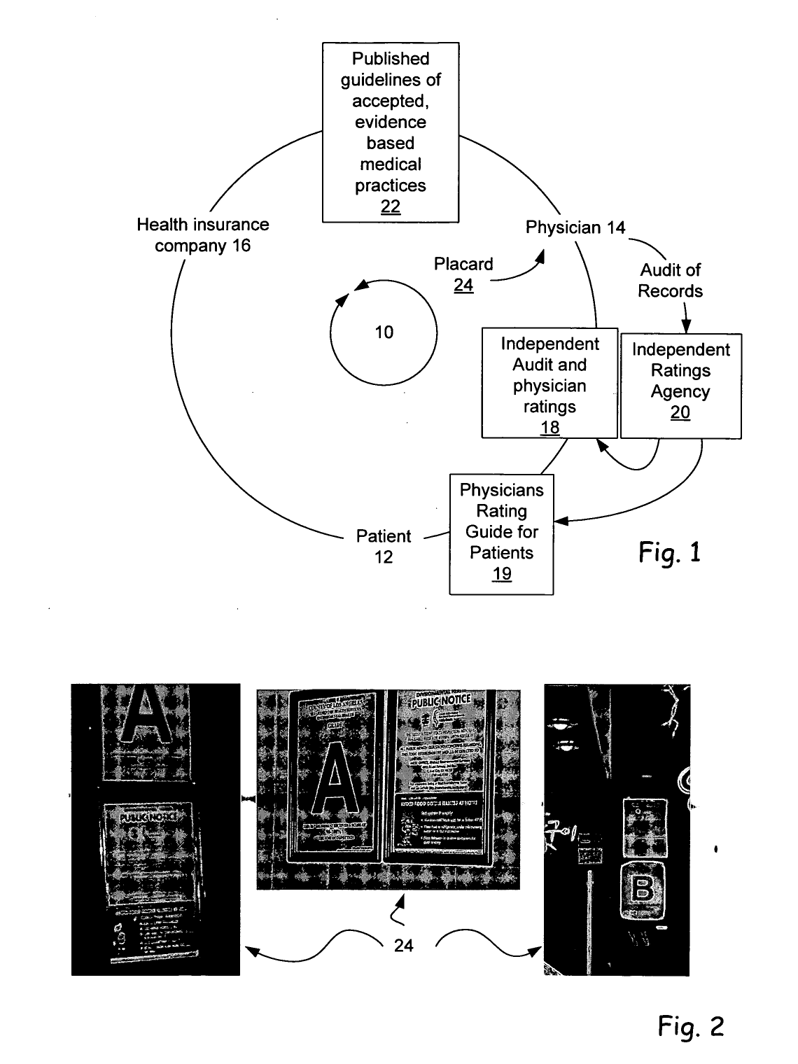

### SUMMARY OF THE INVENTION

A medical rating system may include a set of rules of good medical practice, a rating agency comparing a physicians' records of past practice to the set of rules of good medical practice, a rating of one or more physician's adherence during past practices to the rules of good medical practice for use by a medical insurer in determining repayment to the physician for at least a portion of such past practices, and an easily viewed and understood rating indicator for use by potential patients as an aid in selecting and/or maintaining a relationship with the physician based in part of the physician's adherence during past practice to rules of good medical practice.

### DETAILED DESCRIPTION OF A PREFERRED EMBODIMENT

Referring now to FIG. 2, conventional health care loop 10 includes patent 12 who receives services from physician 14 and provides periodic payments to health insurance company 16. Physician 14 provides services to patent 12 and typically collects payments from health insurance company 16. To complete the loop, health insurance company 16 typically collects payments from patients 12—or from the employer of patent 12 on behalf of patent 12—and pays physician 14.

The health care insurance industry and government have come up with various methods to incentivize best-practices to maximize patient care while controlling costs.

On the cost control side, various partial improvements exist. For example, some health care plans give financial incentives to patients to minimize care through high deductibles and co-pays. On the best-practices side, some companies provide evidence-based “expert systems” that physicians can query to insure adherence to guidelines. These evidence-based expert systems are sold to health-maintenance organizations and doctors to enable those payers to reward doctors and/or patients who adhere to evidenced-based medical recommendations. These HMOs and insurance companies pay for the systems in the belief that the systems will lower cost.

There is evidence that the cost-saving effect from following evidence-based guidelines is real. In April, 2003, a study at Boston's Brigham and Women's hospital found that adhering to evidenced-based guidelines for treating hypertension alone could save at least $1.2B dollars annually in the US. Thus there is a direct link whereby cost-savings result from patients receiving “best practices” care.

Some insurance companies reward doctors and consumers for following a set of evidence-based guidelines provided by the insurance companies. Doctors in these programs may receive higher reimbursement for using the evidence-based system, even if they don't end up adhering to the guidelines in every case—as long as they indicate one of several acceptable reasons for deviating from the recommendations. Moreover, patients are offered a consumer-friendly version of the guidelines, and may get points they can use to lower their co-payments if they correctly answer questions in an online tutorial designed to determine if they understand and are likely to comply with their regimens.

In California, some health plans, insurers and large employer groups have banded together to pay bonuses to doctors who push preventive care and follow-up on patients—moves they say could save billions of dollars and prevent unnecessary hospitalizations and deaths. The top-rated doctors split a bonus pool.

According to the Wall Street Journal, 35 health plans, covering more than 30 million patients, have some kind of program tying doctor bonuses to performance. That number is expected to more than double by next year. General Electric Co., Ford Motor Co. and others are expanding a program, “Bridges to Excellence,” that pays doctors bonuses for treating diabetes and heart patients correctly. The largest health-care payer of all, the Center for Medicare and Medicaid Services, has launched five pilot programs to reward physicians for providing quality care and investing in new technology to better track patients.

Early evidence shows financial incentives can work, but not as well as one would like. For instance, generally accepted medical guidelines say that drugs known as ACE inhibitors should be prescribed to heart-failure patients. But in 1997, the Hawaii Medical Service Association, the largest health plan in that state, says it found such drugs were being prescribed only 40.8% of the time. After a bonus program was put in place to reward doctors for giving ACE inhibitors, that number rose to only 64.2%—a good improvement, but far from 95%+ compliance.

The most important test for diabetics, known as glycosylated hemoglobin, or HbA1c, was being given to only 51.5% of patients, the Hawaiian study found. By 2000, after the incentive plan that rewarded administering the test went into effect, it rose to 79.6%—still far from 95%. Last year, individual doctor bonuses in Hawaii ranged from $500 to $20,000. These results show that a change to the process used to provide health care services and payments can result in societal benefit. What is needed is a better method for providing the proper incentives to doctors other than back-channel bribes and coercion to nudge them to do what they should.

Under the bonus-type programs, with few exceptions, auditors rely primarily on claims data—the coded invoices that doctors submit for reimbursement, showing what services they performed. But critics say that data doesn't always reflect an individual patient's risks, nor does it capture doctor performance versus guidelines 22 in an unambiguous manner. The results of claims auditing are ambiguous because claims data doesn't actually describe what physician 14 does, only what physician 14 and/or patient 12 bills to insurance company 16. Moreover, insurance companies 16 who audit claims data must apply a heuristic algorithm to the claims data to try to guess actual compliance with guidelines 22. This is a flaw in the current practice of auditing claims records at the insurance company level. Moreover, under current programs, less-experienced doctors working longer hours in the ER, for instance, see more patients than older doctors. They therefore get access to more bonus dollars. Some older doctors may not see enough patients for the bonuses, undermining the credibility and breadth of these programs.

In our current health care environment, medical doctors have a perverse incentive to provide unneeded services, and are not penalized for doing so. In fact, the opposite is true. Doctors make more money if they do more tests on their patients. Moreover, if a doctor chooses to skip a test, and that test would have uncovered a disease, the doctor faces a potential malpractice suit. This perverse incentive encourages doctors to over-test-if only to cover themselves against threat of malpractice. In addition, doctors face increasing pressure from consumers to provide additional tests, or to provide treatment plans, that include drugs with big consumer marketing budgets.

Patients see TV ads for certain drugs and go to their doctor and demand them. The doctor has no disincentive to acquiescing to the patients' desires in cases where acquiescing has minimal risks. Moreover, regardless, the doctor gets paid. The only tool which a doctor can use to convince their patient that the advertised drug or treatment plan is unneeded is personal credibility. Moreover, when a doctor defends themselves in malpractice suits, there is no independent rating of the doctor's skill level to use in support of the doctor's credibility. Given the incentives in this system, health care recommendations are skewed.

In almost every industry with large money flows and principal-agent conflicts requiring verification of credibility, there exists a business process whereby one of the parties hires an independent auditor to provide a fairness opinion, or other type of unbiased rating. For instance, if a company wishes to issues stock, they hire an independent auditor to provide an unbiased opinion on their company's adherence to GAAP standards in their public filings. If a company wishes to issue bonds, it hires Moody's, Fitch, or S&P to provide an independent unbiased opinion on its credit worthiness. If a bank wishes to issue a loan, it hires Fair Isaac to provide a FICO score. If an insurance company wishes to sell insurance, it hires AM Best. There are even Zagat guides to help consumers select restaurants. The list of industries relying on independent auditors or evaluators to provide transparency related to adherence to “generally agreed upon” standards is long. Health care is not yet on that list.

One technique to control the spiraling medical costs in the US might be to adopt a national health care system which eliminates perverse incentives between doctors and insurance companies who pay them. This approach has not been popular with America voters.

Another technique to reduce spiraling medical costs and improve care delivered to patients may be to provide transparency to the market so that consumers can purchase medical services with unbiased, 3^{rd} party accumulated, verified, and evaluated information on the credibility of their doctor. In particular, independent audit and physician ratings 18 describing physician auditing results, and/or 3^{rd} party ratings based on those results, formed from audits of medical records and possibly billings as well, may be made available to patient 12 regarding a physician's creditability for example by publishing a guide which rates physicians, such as physicians rating guide for patients 19, including physician 14 so that patient 12 can select physician 14 based in part on credible information related to physician 14 past medical practices regarding adherence to evidence based medical practices. Physicians rating guide 19 could be published in printed or electronic form distributed over a computer network. Guide 19 could be static, or interactive to enable searching for doctors with various specialties, or within specific location or audit parameters.

The use of such public physician rating information has many advantages. For example, in extreme cases, long term patients may select physicians based on the physician's lack of adherence to standardized medical procedures even though this aspect of the physician's practices and procedures may clearly result in reimbursement problems for health costs. However, in the great majority of the cases, standard medical practices may be the most likely to be successful approach and therefore be the most cost effective approach.

Independent audit and physician ratings 18 should be provided by independent ratings agency 20 that provides consumers with a “grade” or score reflecting the doctor's adherence to generally agreed-upon “best care” guidelines.

Agreed upon guidelines 22, such as existing evidence-based medicine guidelines providing recommended treatment plans, may be published and used by independent rating agency 20, together with an audit of the records of many physicians including physician 14, to audit the adherence of physician 14 to best practices 22 in order to produce independent audit and physician ratings 18. Agency 20 should be independent, or at least partially independent of the other parties, but may be paid by them in some combination as well as from other sources such as governmental sources, or employers. Patient 12 may select physician 14 in part based on independent audit and physician ratings 18.

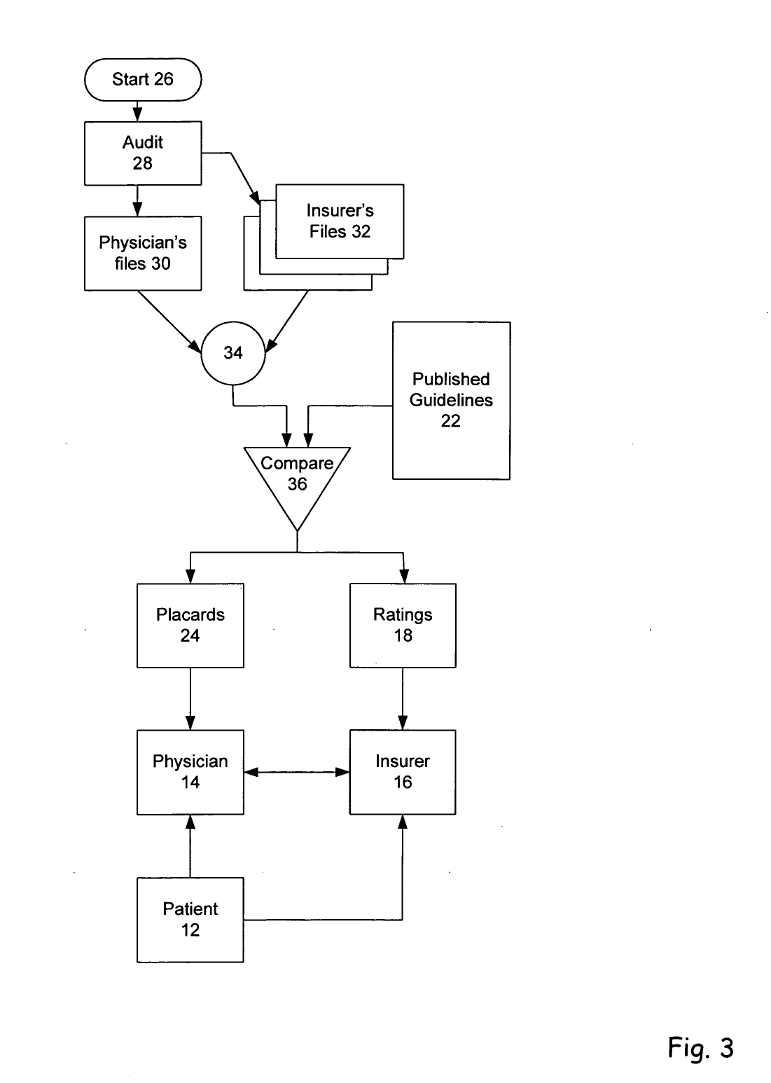

Referring now to FIG. 3, In order to be most effective, however, it is preferable that independent audit and physician ratings 18 be available in a readily usable and understood format by the wide variety of potential patients either at the location or time of treatment, or via a guide for patients, such as physicians rating guide for patients 19 at a different time or place. This may also be accomplished by publication in one or more public media of a shortened version of the audit and rating information in an easily understood format, for example in the form of a letter grade, score, or other rating or ranking describing the physician's or hospital's or other practitioner's adherence to the guidelines 22. In particular, ratings for physicians, such as physician 14 may be in the form of placards 24, such as those used and required to be publicly displayed for providing other services to the public such as restaurant quality placards.

In an extension of the preferred embodiment, physician ratings 18 could be provided in the form of “acknowledgement documents” provided by ratings agency 20 to physician 14 so that physician 14 can provide to said patient 12 before providing service a document to sign acknowledging that said patient has been informed of said physician 14 rating by agency 20.

In a preferred embodiment, an independent company such as rating agency 20, may choose a set of generally accepted guidelines from evidence based medicine such as guidelines 22. An example of one such a guideline might be:
Pediatricians should make sure that at least 98% of their patients receive specific immunizations by age two (excluding those patients, if any, whose parents refuse immunizations).
   There are few doctors that would disagree with this recommended care path, for example. Other evidence-based guidelines would be chosen in such a way that they are clearly measurable similar to the above. These guidelines would be published, for example by agency 20 and may or may not change over time in line with generally accepted evidence-based medical findings.

Agency 20 would then audit the medical records (electronically to the extent possible), or via physical audits of the physician's or other party's manual records, using acceptable sampling methods analogous to those sampling methods used for financial audits. Agency 20, or some other entity such as a state or federal government agency or an industry agency such as a state medical association, would create a ranking scale, such as “A, B, C” and agency 20, another entity would rank, sort, or group physician 14 based on the results of the audit, such as audit ratings 18, as per the audit guidelines 22.

As a result of a physical or electronic medical records audit, with the possible additional auditing of medical claims data, said ratings agency 20 would provide an independent opinion, such as independent audit and physician ratings 18 and/or physicians ratings guide for patients 19 to the doctor who was audited as well as to any insurance payers, such as health insurance company 16 and/or to other interested parties or consumers such as patient 12. In addition, agency 20, or some agency, could provide physician 14 with some sort of poster or certificate for display of their rating to the public or permit physician 14 to display an approved rating. This poster might be similar to the “A, B, C” grades that the LA Health Department gives to restaurants in Los Angeles as shown in FIG. 2 as ratings placards 24. It is hoped that doctors who receive an “A” grade might post their rating. Perhaps, over time, legislation might require all doctor's to post their ratings. As well, it might be in the form of a “patient acknowledgement” form provided by agency 20, or quoting the ratings issued by agency 20, provided by any party to patient 14 for review or acceptance.

In the preferred embodiment, an “A” grade might indicate that physician 14 met the minimum published standard for compliance to the published guidelines 22. A “B” grade might indicate that physician 14 failed to meet the minimum published standard for compliance. A “C” grade would indicate that, regardless of compliance with minimum published standards, the doctor's license is under review by the relevant medical accreditation authorities for possible revocation., or some other important information related to physician censuring. In this way, most doctors should be able to get an “A” grade simply by providing the best possible care; just as most companies are able to get positive opinions on the fairness of their financial statements from their independent auditors. In addition to the three grades, or levels that are publicly disseminated to consumers; any sort of additional ranking may be used including “1-100%”, “1, 2, 3 . . . ”, or any sort of cardinal or ordinal, or even free-form, ranking system.

Just as the “A, B, C” letter grading system of restaurant cleanliness in Los Angeles has provided transparency to consumers about the healthfulness of restaurants; this preferred embodiment will provide similar transparency to consumers about the healthfulness of their chosen doctors.

As an extension of the preferred embodiment, the hospitals might only permit doctors rated “A” to practice in their hospital—with unaudited doctors, or those who receive “B” for more than a certain probationary period—excluded from using those hospital's facilities.

As an extension of the preferred embodiment, the bill for auditing of doctors might be paid by health insurance companies, government agencies such as Medicare, and/or bands of employers, such as the Leapfrog Group, a coalition of employer health plans that spends about $62 billion annually for health care, or individual employers. These payers for health care would purchase the independent auditors' services because of the direct correlation between quality care and health care savings.

In operation, statistical audits of medical records via ratings agency 20 might be similar to the process of financial auditing firms. The development of an operation system may start regionally and could be driven by employer demand and/or funding. In addition, a trial may be funded by a governmental agency, such as the Veteran's Administration and/or Medicare which may use specialized funding such as their pilot EBM funds

Different sources of funding may be used, and/or combined:
insurers may pay for the audit results
where employers and other insurance buyers may be the primary payers for the audit results as they benefit from the results of a Pay for Performance Plan
physicians may pay for the audit results
the data may be sold or licensed for limited usage
physicians may pay for re-audits of their practice if they wish to have their score reviewed.

In the preferred embodiment, agency 20 may will sign other Insurance Carriers, VA, Medicare, HMOs, city health plans. They will have a superior supplier status versus any insurance provider or employer choosing to perform this medical auditing service in-house because of:
Economies of Scale (low cost supplier)
Easier to get AMA support by working with Ambulatory Care Quality Alliance
Hard for Physicians to argue with common sense (the Oprah factor)
Potential liability relief to Insurers—eliminates ratings based heuristics applied to billings. Replaces it with audits of actual medical records
   The data on physician procedures performed may be gained either through:
In person audits of medical records.
Review of electronic medical records transmitted over a network or any type of computer connection.
Review of submitting claims and reimbursement data on those claims.
Or a combination of the above.

This data could be used to compare the physician procedures performed with standard treatments and procedures suggested by industry and government partnerships who are already codifying best practices and developing evidence-based medicine (EBM) datasets. These industry and government partnerships and organizations include:
NCQA: National Committee for Quality Assurance (www.ncqa.org).
JCAHO: Joint Commission on Accreditation of Healthcare Organizations (http://www.jcaho.org/).
ACQA: Ambulatory Care Quality Alliance (http://www.ambulatoryqualityalliance.org/).
Heart Association, Diabetes Association, . . . .
NIH: National Institute of Health.
Universities.

The history of Evidence Based Medicine (EBM) Guidelines may be traced to Professor Archie Cochrane, a British medical researcher whose book Effectiveness and Efficiency: Random Reflections on Health Services (1972) and subsequent advocacy caused increasing acceptance of the evidence-based medicine concept. Cochrane's work was honored through the naming of centers of evidence-based medical research—Cochrane Centers—and an international organization, the Cochrane Collaboration.

Techniques for stratifying evidence by quality may be used and have been developed, such as the following one developed by the U.S. Preventive Services Task Force:
Level I: Evidence obtained from at least one properly designed randomized controlled trial.
Level II-1: Evidence obtained from well-designed controlled trials without randomization.
Level II-2: Evidence obtained from well-designed cohort or case-control analytic studies, preferably from more than one center or research group.
Level II-3: Evidence obtained from multiple time series with or without the intervention. Dramatic results in uncontrolled could also be regarded as this type of evidence.
Level III: Opinions of respected authorities, based on clinical experience, descriptive studies, or reports of expert committees.

In guidelines and other publications recommendations may be categorized according to the level of evidence they are based on. The U.S. Preventive Service Task Force uses:
Level A: Recommendations are based on good and consistent scientific evidence.
Level B: Recommendations are based on limited or inconsistent scientific evidence.
Level C: Recommendations are based primarily on consensus and expert opinion.

As an example, a RECOMMENDED STARTER SET CLINICAL PERFORMANCE MEASURES FOR AMBULATORY CARE is described in the form of a news article.

At the Jan. 17th-18th meeting, the large stakeholder group directed the Performance Measurement Workgroup met to propose a starter set of measures for ambulatory care, which align with agreed-upon parameters and address agreed-upon specific conditions/areas. The workgroup is recommending that the performance measures contained in this document serve as this starter set.

This recommendation was developed by the workgroup after significant discussion. The workgroup started with the “straw man” list of measures presented at the January meeting—all of which were part of the CMS-AMA Physician Consortium-NCQA ambulatory care performance measurement set that was submitted to NQF for expedited review. Utilizing a modified “Delphi” exercise to help facilitate the discussion, the workgroup considered and primarily selected measures based on their ability to meet the following criteria: (1) clinical importance and scientific validity; (2) feasibility; (3) relevance to physician performance; (4) consumer relevance; and (5) purchaser relevance. Other factors considered include whether measures were preliminarily approved by NQF's expedited review process and comments made during the last stakeholder meeting in January. While the workgroup believes that this is a sound set of measures that meets primary goals, such as addressing the IOM's priority areas, they continue to recognize that this is an initial step in a multi-year process. Additional work needs to be done to build a more complete set of measures, which includes additional efficiency measures, sub-specialty measures, cross-cutting measures, patient experience measures and others.

Prevention Measures

| | | |
|---|---|---|
| 1. | Breast Cancer Screening | Percentage of women who had a mammogram during the measurement year |
| | | or year prior to the measurement year. |
| 2. | Colorectal Cancer Screening | The percentage of adults who had an appropriate screening for |
| | | colorectal cancer. |
| | | One or more of the following: |
| | | FOBT - during measurement year; |
| | | Flexible sigmoidoscopy - during the measurement year or the |
| | | four years prior to the measurement year; |
| | | DCBE - during the measurement year or the four years prior; |
| | | Colonoscopy - during the measurement or nine years prior. |
| 3. | Cervical Cancer Screening | Percentage of women who had one or more Pap tests during the |
| | | measurement year or the two prior years. |
| 4. | Tobacco Use | Percentage of patients who were queried about tobacco use one or |
| | | more times during the two-year measurement period. |
| 5. | Advising Smokers to Quit | Percentage of patients who received advice to quit smoking. |
| 6. | Influenza Vaccination | Percentage of patients 50-64 who received an influenza vaccination. |
| | | Note: NQF also preliminarily approved this measure for patients |
| | | 65 and older. |
| 7. | Pneumonia Vaccination | Percentage of patients who ever received a pneumococcal vaccine. |

Coronary: Artery Disease (CAD)

| | | |
|---|---|---|
| 8. | Drug Therapy for Lowering | Percentage of patients with CAD who were prescribed a |
| | LDL Cholesterol | lipid-lowering therapy (based on current ACC/AHA guidelines). |
| 9. | Beta-Blocker Treatment | Percentage of patients hospitalized with acute myocardial |
| | after Heart Attack | infarction (AMI) who received an ambulatory prescription |
| | | for beta-blocker therapy (within 7 days discharge). |
| 10. | Beta-Blocker Therapy - | Percentage patients hospitalized with AMI who received persistent |
| | Post MI | beta-blocker treatment (6 months after discharge). |

Heart Failure

| 11. | ACE Inhibitor/ARB Therapy | Percentage of patients with heart failure who also have LVSD who |
|---|---|---|
| | | were prescribed ACE inhibitor or ARB therapy. Angiotensin receptor |
| | | blocker (ARB) drugs are collected under this measure. |
| 12. | LVF Assessment | Percentage of patients with heart failure with quantitative or |
| | | qualitative results of LVF assessment recorded. |
| Diabetes | | Diabetes Note: These measures were not approved during the NQF |
| | | expedited review, as NQF has taken previous action on diabetes |
| | | measures. |
| 13. | HbA1C Management | Percentage of patients with diabetes with one or more A1C test(s) |
| | | conducted during the measurement year. |
| 14. | HbA1C Management Control | Percentage of patients with diabetes with most recent A1C level |
| | | greater than 9.0% (poor control). |
| 15. | Blood Pressure Management | Percentage of patients with diabetes who had their blood pressure |
| | | documented in the past year less than 140/90 mm Hg. |
| 16. | Lipid Measurement | Percentage of patients with diabetes with at least one Low Density |
| | | Lipoprotein cholesterol (LDL-C) test (or ALL component tests). |
| 17. | LDL Cholesterol Level | Percentage of patients with diabetes with most recent LDL-C less |
| | (<130 mg/dL) | than 100 mg/dL or less than 130 mg/dL. |
| 18. | Eye Exam | Percentage of patients who received a retinal or dilated eye exam |
| | | by an eye care professional (optometrist or ophthalmologist) during |
| | | the reporting year or during the prior year if patient is at low |
| | | risk for retinopathy. A patient is considered low risk if all three |
| | | of the following criteria are met: (1) the patient is not taking |
| | | insulin; (2) has an A1C less than 8.0%; and (3) has no evidence of |
| | | retinopathy in the prior year. |

Asthma

| | | |
|---|---|---|
| 19. | Use of Appropriate | Percentage of individuals who were identified as having persistent |
| | Medications for | asthma during the year prior to the measurement year and who were |
| | People w/Asthma | appropriately prescribed asthma medications (e.g. inhaled |
| | | corticosteroids) during the measurement year |
| 20. | Asthma: | Percentage of all individuals with mild, moderate, or severe |
| | Pharmacologic Therapy | persistent asthma who were prescribed either the preferred |
| | | long-term control medication (inhaled corticosteroid) or an |
| | | acceptable alternative treatment. |

Depression

| | | |
|---|---|---|
| 21. | Antidepressant Medication | Acute Phase: Percentage of adults who were diagnosed with a new |
| | Management | episode of depression and treated with an antidepressant medication |
| | | and remained on an antidepressant drug during the entire 84-day |
| | | (12-week) Acute Treatment Phase. |
| 22. | Antidepressant Medication | Continuation Phase: Percentage of adults who were diagnosed with a |
| | Management | new episode of depression and treated with an antidepressant |
| | | medication and remained on an antidepressant drug for at least 180 |
| | | days (6 months). |

Prenatal Care

| | | |
|---|---|---|
| 23. | Screening for Human | Percentage of patients who were screened for HIV infection during |
| | Immunodeficiency Virus | the first or second prenatal visit. |
| 24. | Anti-D Immune Globulin | Percentage of D (Rh) negative, unsensitized patients who received |
| | | anti-D immune globulin at 26-30 weeks gestation. |

Quality Measures Addressing Overuse or Misuse

| | | |
|---|---|---|
| 25. | Appropriate Treatment for | Percentage of patients who were given a diagnosis of URI and were |
| | Children with Upper | not dispensed an antibiotic prescription on or 3 days after the |
| | Respiratory Infection (URI) | episode date. |
| 26. | Appropriate Testing for | Percentage of patients who were diagnosed with pharyngitis, |
| | Children with Pharyngitis | prescribed an antibiotic and who received a group A streptococcus |
| | | test for the episode. |

Referring now to FIG. 3, in operation, upon start 26, audit step 28 may be performed physically or electronically on a statistically significant subset of physician's files 30 and/or insurer's files 32 regarding physician 14.

There may be more than one set of insurer's files 32 because the same physician 14 may provide services for patients insured by different entities. The results of audit 28 may be combined in combiner 34 if multiple sources of records are provided. Combiner 34 may treat information from insurer files 32 differently than information from physician files 30, by for example weighting them differently, as part of the combination. The audited record results after combining are compared in comparator 36 with guidelines 22 or another source good practice rules such as evidence based rules.

Alternately, each set of records, such as the physician's files or one or more files from an insurer, may be first compared with the published guidelines and be combined with others. Still further, it may be advantageous to merge these approaches and combine some files or records before comparison with other files and records.

The result of the comparison may be one or more types of ratings, such as independent audit and physician rating 18, physicians rating guide 19, placard ratings 24 and/or another mechanism for publishing the ratings and/or making them available to interested parties.

Placards 24, if provided, may conveniently be displayed in the offices of audited physician 14 for viewing or otherwise acknowledging by potential patient 12. More detailed rating information such as audit records 18 may be provided to insurer 16 for use by the insurer in determining repayment to physician 14. Patient 12 makes periodic payments, directly or indirectly to insurer 16.

1. A medical rating system comprising:
a set of rules of good medical practice;
a rating agency comparing a physicians' records of past practice to the set of rules of good medical practice;
a rating of one or more physician's adherence during past practices to the rules of good medical practice for use by a medical insurer in determining repayment to the physician for at least a portion of such past practices; and
an easily viewed and understood rating indicator for use by potential patients as an aid in selecting and/or maintaining a relationship with the physician based in part of the physician's adherence during past practice to rules of good medical practice.
